(19) United States
(12) Patent Application Publication
(10) Pub. No.: US 2014/0214812 A1
(43) Pub. Date: Jul. 31, 2014

(54) SOURCE CODE PRIORITY RANKING FOR FASTER SEARCHING

(71) Applicant: Goole Inc., Mountain View, CA (US)

(72) Inventor: James Benjamin St. John, Eichenau (DE)

(73) Assignee: Goole Inc., Mountain View, CA (US)

(21) Appl. No.: 13/644,306

(22) Filed: Oct. 4, 2012

(51) Int. Cl. G06F 17/30

(52) U.S. Cl. 707/723; 707/E17.014

(57) ABSTRACT

A system is disclosed for using features of source code to provide more relevant search results in a timelier manner. The system includes at least one processor and a memory storing instructions configured to cause the system to calculate a priority score for each file in associated with a code repository. The priority score is based on at least one of a version score, a build status score, a momentum score, and a social score. The instructions may cause the system to store the priority score in a memory. The instructions may also cause the system to receive a search query, use the stored priority scores to identify files in the code repository responsive to the query, and generate data used to display the identified files. The display may include depictions of the scores used to calculate a priority score for the identified files.

### TECHNICAL FIELD

This description relates to searching document repositories and, more specifically, to assigning documents a priority score used to increase the quality of search results and the speed with which the search results are returned.

### BACKGROUND

Software applications are often made up of many individual files written by various software developers, with each file containing software code that performs certain functions. As a software project grows in scope, the number and size of the individual files grows, as does the number of software developers working on the project. To manage large scale software projects, many organizations store software in a central location, often referred to as a code repository. The code repository often includes a version control system that keeps track of the various versions of software, the identity of a person who has modified each the file, the identify of a person who has checked a file out of the repository, etc. Often, a storage system with version control allows an organization to track versions of the code files and requires authorization to access or update the files. However, code repositories may also be a designated directory or directories on a networked computing device without a version control system.

One of the advantages of storing code in a central location is the ability to search the stored code. While this is not a feature generally supplied with or inherent in a code repository or a version control system, such functionality may be provided by, for example, a source code search engine. But, searching a source code repository presents problems and opportunities distinct from searching other types of documents. In particular, a search engine for a code repository may not be able to rank source code using the same algorithms as those used to rank web documents. Furthermore, traditional search engines lack a way to prioritize source files and/or functions that takes advantage of the properties of source code files. Thus, a challenge remains to create tools that efficiently and effectively search a source code repository.

### SUMMARY

One aspect of the disclosure can be embodied in a method that includes, for each file associated with a code repository, calculating a priority score for the file, wherein the priority score is based on at least one of a version score, a build status, a momentum score, and a social score. The method may also include storing the priority score in a memory, receiving a search query for the code repository, and using the priority score to generate a result list of files in the code repository responsive to the query. The method may also include generating data used to display the result list.

These and other aspects can include one or more of the following features. For example, using the priority score to identify files may include initially limiting the files searched for responsiveness to files having a minimum priority score. As another example, using the priority score to identify files may include initially limiting the files searched for responsiveness to files having a minimum priority score. In some implementations, the method may include combining the priority score and a relevance score for each of the files in the result list, and ordering the result list based on the combined priority score and relevance score. In some implementations, the momentum score may be based on a frequency with which the file changes and a first file with an increasing number of changes over a time period has a higher momentum score than a second file with a decreasing number of changes over the time period. The momentum score may also be is based on the number of contributors to the file and a first file with an increasing number of contributors over a time period has a higher momentum score than a second file with a decreasing number of contributors over the time period, and/or be based on bug reports for a project associated with the file.

In some implementations the social score may be based on the number of contributors that have marked the file as important. The social score may also be stored by work group and, after receiving the search query. In such implementations, the method may include determining a work group to which a requestor of the query belongs, and boosting the priority score when the work group to which the requestor belongs has a non-zero social score. In some implementations the build status may reduce the priority score for a file. The reduction may be based on a date the file was last modified. For example, a first file with a more recent modified date may have a smaller score reduction than a second file with an older modified date and/or the priority score reduction may be zero for a first file when a modified date newer than a threshold date. In some implementations, an older version of a file may have a lower version score than a more recent version of the file. In some implementations the displayed result may include visual indications of the scores used in the priority score of a particular document.

Another aspect of the disclosure can be a system for searching documents that includes one or more processors and a memory storing instructions that, when executed by the one or more processors, are configured to cause the system to perform operations. The operations may include, for each file associated with a code repository, calculating a priority score for the file, and storing the priority score in a memory. The priority score may be based on at least one of a version score, a build status, a momentum score, and a social score. The operations may further include, receiving a search query for the code repository, using the priority score to generate a result list of files in the code repository responsive to the query; and generating data used to display the result list.

These and other aspects can include one or more of the following features. For example, the momentum score may be have a higher weighting than the build status and the social score for the file in the priority score. As another example, the build status may reduce the priority score for a file. In some implementations the build status may be based on a build status history for the file. In some implementations, the instructions may further be configured to cause the system to perform the operation of ordering the result list based on the priority score and a relevance score. In some implementations, the priority score is based on at least the version score and as part of the calculating operation the instructions perform the operations of receiving an indication that older versions are more desirable and inverting the version score prior to calculating the priority score.

Another aspect of the disclosure can be a tangible computer-readable storage device having recorded and embodied thereon instructions that, when executed by one or more processors of a computer system, cause the computer system to, for each file associated with a code repository, calculate a priority score for the file, wherein the priority score is based on at least one of a version score, a build status, a momentum score, and a social score. The instructions may also cause the computer system to store the priority score in a memory, receive a search query for the code repository, and use the priority score to generate a result list of files in the code repository responsive to the query. The instructions may further cause the computer system to generate data used to display the result list.

The details of one or more implementations are set forth in the accompanying drawings and the description below. Other features will be apparent from the description and drawings, and from the claims.

### BRIEF DESCRIPTION OF DRAWINGS

FIG. 1 illustrates an example system in accordance with the disclosed subject matter.

FIG. 2 is a flow diagram illustrating a process for creating and using a priority score used to respond to search queries, consistent with disclosed implementations.

FIG. 3 is a flow diagram illustrating a process for creating a priority score for a particular file, consistent with disclosed implementations.

FIG. 4 is an example of a code repository index and search results generated using methods and systems in accordance with disclosed implementations.

FIG. 5 is an example of a user interface showing a results list after searching a code repository, consistent with disclosed implementations.

FIG. 6 shows an example of a computer device that can be used to implement the described techniques.

Like reference symbols in the various drawings indicate like elements.

### DETAILED DESCRIPTION

Disclosed implementations provide source code search systems and methods that take advantage of features source code to provide more relevant results in a timelier manner. In some implementations, the system may calculate a priority score for the various files in the code repository. In some implementations, the priority score may be independent of any particular search query and may be pre-calculated before a search query is received. The priority score may be based on one or more characteristics of each file in a code repository. Such characteristics may include the version, the build status, the momentum, and the developer-defined popularity, as well as on other factors such as how often other files reference the file, how often other files reference the symbols defined in the file, or the file type. The priority score may be calculated at any time, such as daily, weekly, or in response to a particular file being updated. The priority score may be stored in the source code search system so that the system may easily access the score when a query is received.

In order to improve the response time for processing a query, disclosed implementations may use the priority score in responding to a search query. For example, the search system may initially only search files for relevance to the query that have a minimum priority score, to ensure that the first set of results presented to the query requestor contain the highest priority documents. In some implementations the priority score may be combined with a relevance score to order the result list, causing high priority documents to appear higher in the result list than their relevance score dictates. In some implementations, the priority score may offer a secondary sort option when documents have the same or similar relevance scores. In some implementations, the search system may search the documents in order of decreasing priority, so that the first x documents that match the query are returned to the query requestor. These methods allow the search system to quickly return a result list while still ensuring that the quality remains high.

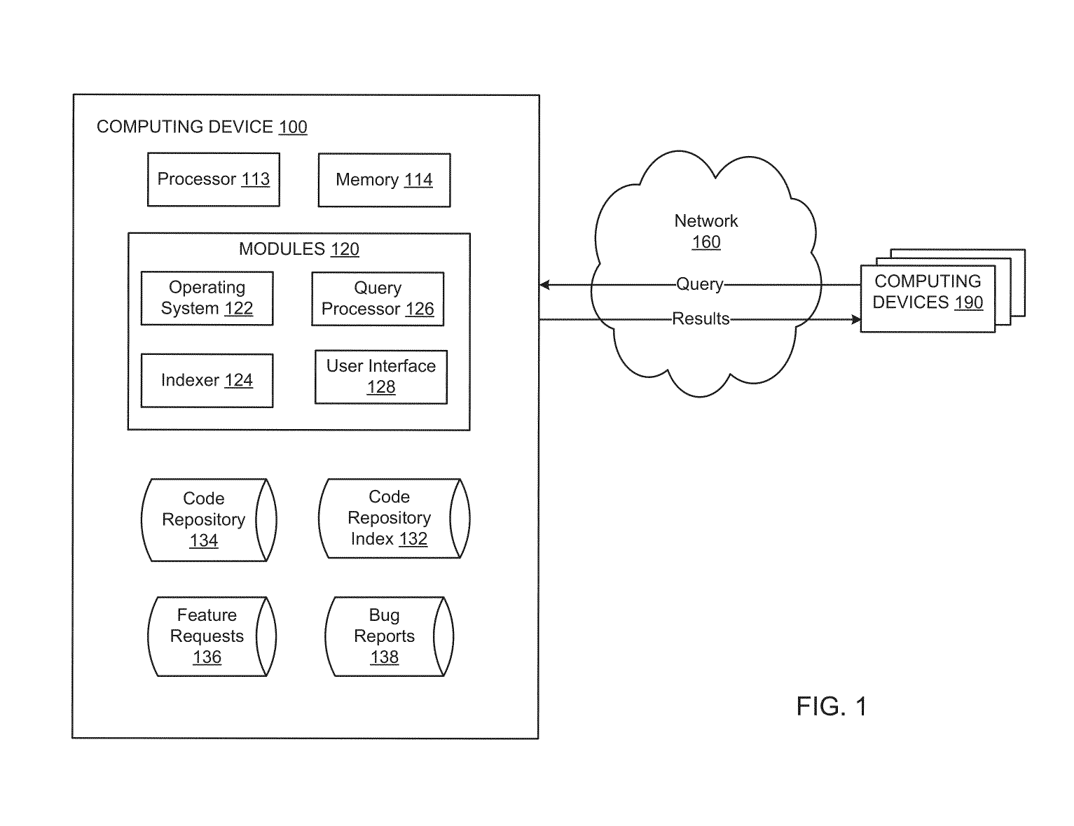

FIG. 1 is a block diagram of a computing device 100 in accordance with an example implementation. The computing device 100 may be used to implement the search techniques described herein. The depiction of computing device 100 in FIG. 1 is described as a source code search system. Source code may include files of any type that contain statements intended to be interpreted by a processor of a computing device, whether by compilation or interpretation. But, it will be appreciated that the search techniques described may be used in other configurations where the files contain similar properties, such as versioning, tracking of contributors, error tracking, etc. Accordingly, source code is used as one example of type of files that may be used in various implementations and is used to represent any type of file, whether source code or other content.

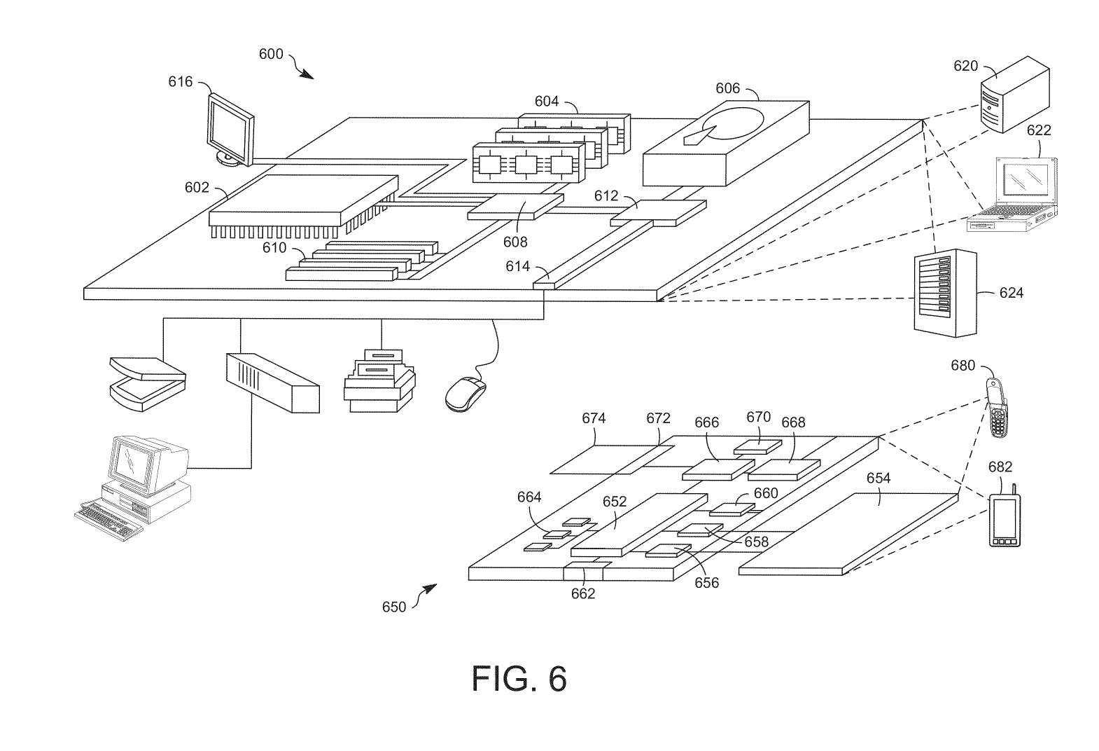

The computing device 100 may be a computing device that takes the form of a number of different devices, for example, a standard server, a group of such servers, or a rack server system. In some implementations, computing device 100 may be implemented in a personal computer, or a laptop computer. In some implementations, computing device 100 may include two or more computing devices. The computing device 100 may be an example of computer device 600, as depicted in FIG. 6.

Computing device 100 can include one or more processors 113 configured to execute one or more machine executable instructions or pieces of software, firmware, or a combination thereof. The computing device 100 can include an operating system 122 and one or more computer memories 114, for example a main memory, configured to store data, either temporarily, permanently, semi-permanently, or a combination thereof. The memory 114 may include any type of storage device that stores information in a format that can be read and/or executed by processor 113. Memory 114 may include volatile memory, non-volatile memory, or a combination thereof. In some implementations memory 114 may store modules, for example modules 120. In some implementations modules 120 may be stored in an external storage device (not shown) and loaded into memory 114. The modules 120, when executed by processor 113, may cause processor 113 to perform certain operations.

For example, in addition to operating system 122, modules 120 may also include an indexer 124 that enables computing device 100 to calculate a priority score for one or more files in a repository as well as perform other functions to create index 132, used to search a code repository 134. Modules 120 may also include a query processor 126 that receives a query from a requestor and uses index 132 to generate a result list for the query. User interface 128 may pass the query to query processor 126 and may send the result list to the query requestor, such as a user of computing device 190.

Computing devices 190 may be any type of computing device in communication with computing device 100, for example, over network 160. Computing devices 190 may include desktops, laptops, tablet computers, mobile phones, smart phones, etc. In some implementations, computing device 190 may be part of computing device 100 rather than a separate computing device. User interface module 128 may provide a user interface to the user of computing device 190 that allows the user to submit queries to the query processor 126 and to receive query results from query processor 126.

Computing device 100 may be in communication with the computing devices 190 over network 160. Network 160 may be for example, the Internet or the network 160 can be a wired or wireless local area network (LAN), wide area network (WAN), etc., implemented using, for example, gateway devices, bridges, switches, and/or so forth. Via the network 160, the computing device 100 may communicate with and transmit data from computing devices 190. In some implementations computing devices 190 may be incorporated into and part of computing device 100, making network 160 unnecessary.

Computing device 100 may also include several data stores, which may be stored in memory 114, in a memory accessible to computing device 100, or in a computing device separate from computing device 100. The data stores may include a code repository 134, a code repository index 132, feature requests 136, and bug reports 138. Code repository 134, code repository index 132, feature requests 136, and bug reports 138 need not be stored in the same memory or even on the same computing device.

In some implementations, code repository 134 may be part of a version control system, and therefore may include data concerning various versions of a file, such as the changes made, the date and time of the changes, the authors of the changes, etc. In some implementations code repository 134 may include a directory and its various sub-directories on a storage device. In such an implementation version and author information may be derived from the file or directory names. Code repository index 132 may be an index used to search the code repository 134 for clones and may be created and updated as code is added to the code repository 134. In some implementations, indexer 124 may create or update code repository index 132 at set intervals of time, such as daily, twice a day, weekly, etc. In some implementations, indexer 124 may update code repository index 132 as files are updated/saved in the code repository 134. Query processor 126 may use code repository index 132 to respond to search queries directed at code repository 134.

Computing device 100 may include feature requests 136 and bug reports 138. As software is developed and tested, users may find errors in the software or may determine that additional functionality would improve the software. The errors are generally referred to as bugs, and a user may report a bug to the software developers to be fixed. Such bug reports may be saved in bug reports 138. For example, a user may enter a bug report through, e.g., user interface 128, and the bug may be saved in bug reports 138. The bug reports 138 may indicate who reported the bug, what files are affected by the bug, what behavior is caused by the bug, and who is assigned to fix the bug, and when the bug was fixed.

In addition to reporting bugs, users may also request additional functionality be added to the software. Rather than reporting code that does not work, feature requests indicate additional functionality that a user would like the software to perform. Like bugs, a feature request may be associated with a particular source code file, have an associated requestor, have a request date, etc. As explained above, feature requests 136 and bug reports 138 may be located in a computing device separate from, but accessible by, computing device 100.

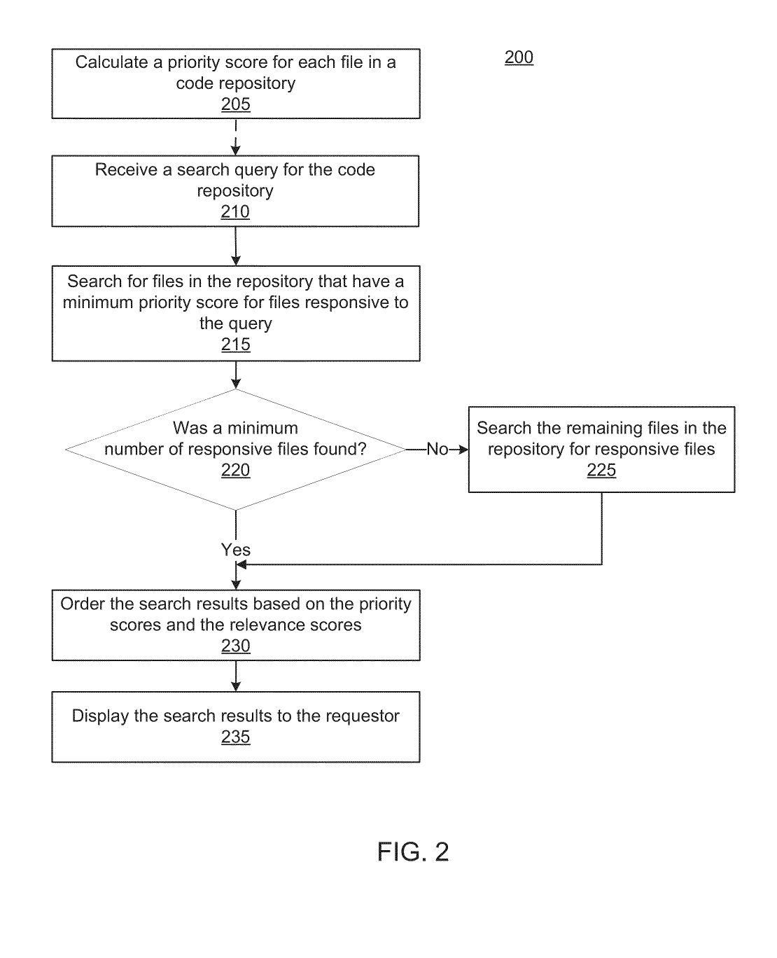

FIG. 2 is a flow diagram illustrating a process 200 for creating and using a priority score used to respond to search queries, in accordance with disclosed implementations. Process 200 shown in FIG. 2 may be performed by a search system, such as computing device 100 in FIG. 1. In some implementations indexer 124 may create a priority score for each file and query processor 126 may use the priority score when responding to queries. The priority score may be stored, for example, as part of code repository index 132. Process 200 may begin with the indexer 124 creating a priority score for each file in a code repository (step 205). For example, indexer 124 may calculate the priority score on a set schedule, such as daily, every n days, weekly, etc., or indexer 124 may create the score for each file as the file is added or saved to code repository 134. In some implementations, indexer 124 may create or update the priority score as changes are made to a particular file in the code repository 134.

After and independent from the indexer 124 creating the priority scores, denoted by the dashed line in FIG. 2, the query processor 126 may receive a search query directed to the code repository (step 210). In response, the query processor 126 may use the priority score for each file to identify search results to be returned to the query requestor. For example, query processor 126 may initially search the files in the code repository 134 that have a minimum priority score (step 215). Query processor 126 may determine whether a minimum number of results were found in the initial search (step 220). If a minimum number was not found (step 220, No), then query processor 126 may search the remaining files, regardless of priority score, to find the minimum number. After identifying the responsive files, query processor 126 may order the search results based on the priority scores and the relevance scores (step 230) for the identified files. In one implementation, the research results may be ordered first by relevance score and next by priority score, so that for files having the same relevance score, the files with the higher priority scores are listed first. In other implementations, query processor 126 may combine the relevance and priority scores and order the files based on the combined score. For example, the priority score and the relevance score may be added together or may be averaged, or a relevance boost may be given to files having a priority score in a predetermined range, with a larger boost given to files with priority scores in the higher ranges and a lower boost given to files in lower ranges.

In some implementations (not shown), query processor 126 may use the priority score in other ways to limit the documents searched. For example, query processor 126 may retrieve the files in order of descending priority score and consider the first n responsive files to be the results list. In such implementations query processor 126 may not use the priority scores to order the search results. Using the priority score to limit the search allows the query processor 126 to provide much faster query results while still keeping the quality high. Once query processor 126 has obtained the search results, query processor 126 may generate data used to display the search results to the query requestor (step 235) and process 200 ends.

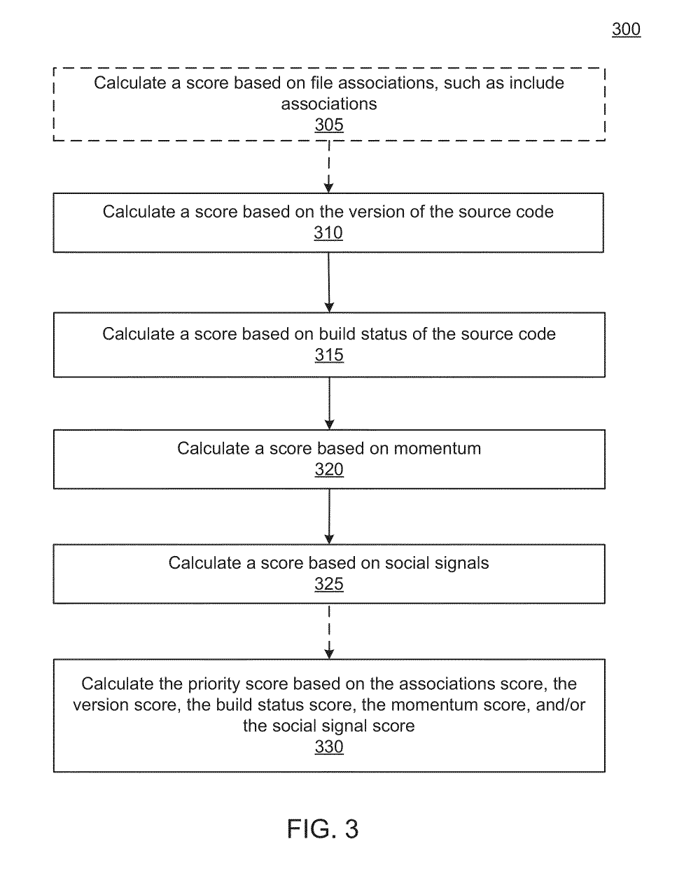

FIG. 3 is a flow diagram illustrating a process 300 for creating the priority score for a file, in accordance with disclosed implementations. Process 300 shown in FIG. 3 may be performed by an indexer (e.g., indexer 124 shown in FIG. 1). Process 300 may begin with the indexer 124 calculating a score based on associations, such as include associations and symbol associations (step 305). As one example, when source code is written, most programming languages allow the developer to set up dependencies on other files using, for example, the “#include” statement in C++ and the “import” statement in Java® and Python®. Indexer 124 may set a higher association score for files that are frequently included in other programs. Other similar types of associates may also be included in the calculated association score. In some implementations indexer 124 stores the calculated association score for each file as part of code repository index 132.

Indexer 124 may also calculate a version score for the file (step 310). The version score may indicate how old the particular file is. In some implementations that use a version control system, developers may keep and check-in various versions of a file. The version control system may track each version, so that when a new version is checked-in or saved, the old version is archived. In such implementations, the indexer 124 may favor the most recent version of a file, so that current versions have a higher version score than past versions. In some implementations, a version may be derived from the name of the file or from the directory the file is stored in. For example, if a directory has “archive” in its name, the files located in that directory may receive a lower version score. In some implementations, the query processor 126 may allow a user to specify that older versions should be given higher priority. In such implementations, query processor 126 may invert the version score for a file, so that high scores become low and vice-versa. Such an option may be useful for a query requestor wanting to specifically search older source code. Thus, in some implementations indexer 124 stores the version score for each file as part of the code repository index 132.

Indexer 124 may also calculate a build status score for each file (step 315). A build refers to a compile of the source code. Compiling the code converts the source code to machine code that can be executed by a processor. If the source code contains syntax errors the build will not be successful. As source code becomes older and obsolete, the code may no longer successfully compile because, for example, its dependencies on other functions or symbols have changed and are no longer compatible. The indexer 124 may look at whether the build succeeded or not and may set a higher build status score for source code that does not compile and a lower build status score, such as zero, for source code that does compile. In some implementations, the build status score may be based on the type and or number of errors found during the compile. For example, warnings may receive a lower build status score than actual errors. The build score may be used to lower the overall priority score of a source code file. In some implementations indexer 124 may attempt to compile the source code files as it parses the files for symbols, for example, as part of optional step 305. If a file does not successfully compile, indexer 124 may set an appropriate build score for the file. Because the build score may be used to deflate the overall priority score, a lower build status score indicates a more desirable file.

In some implementations indexer 124 may take into account the age of the file or the build status history when setting the build status score. For example, source code that is currently being developed by a work group may not successfully compile because the software developers have not yet completed changes. In this situation indexer 124 may decrease or set to zero the build status score because the unsuccessful compile is due to current work on the file and not to the file's lack of use. To determine whether a source code file is old or new, indexer 124 may, for example, take into account the timestamp of the last change. In some implementations, the build status score may be zero if the last modified date for a file is more recent that some threshold date. In some implementations, indexer 124 or some other module may track the build history of a file. A build history stores information on previous complies of a file and whether they compiles were successful or not. Thus, a build status score may account for the build history. A file that successfully compiled the time just prior may receive a lower build status score than a file that has not compiled successfully the previous time. The build history need not track each compile of the source code, but may store the build status for a periodic basis, such as once a week. In some implementations the build history may be calculated or deduced from prior build status cores for the file. Using these methods and those like them, indexer 124 may include some smoothing to ensure that time is considered before setting a build status score. Indexer 124 may store the build status score for each file as part of the code repository index 132.

Indexer 124 may also calculate a momentum score for the file (step 320). The momentum score may include several time-related factors. For example, momentum may reflect the trend of various items, such as the number of changes to the file, the number of contributors to the file, number of feature requests, and the number of bugs reported. Each of these measures offers insight into how current and important a file is. For example, indexer 124 may assign a higher momentum score to files that received recent changes because this indicates that the code is currently under development. Indexer 124 may also assign a higher momentum score to a file with a growing number of contributors as this is an indication of an important file that is currently under development. Similarly, a file that has recently received many feature requests or bug reports may also receive a high momentum score from indexer 124.

In determining momentum, indexer 124 may use some averaging over time with a decay so that only recent trends cause a file to receive a priority score boost due to momentum. In other words, a file that changes often today may receive a higher momentum score than a file that changed often last week, but has only changed one time in the last week. Similarly, a file that has many contributors in the last day may receive a score that is higher than a file that had many contributors a month ago but only one contributor recently. In any of these situations, indexer 124 may consider the trend more important than the actual numbers. For example, a file with two feature requests last week and five today may receive a higher momentum score than a file that had ten feature requests last week and five today. Accordingly, indexer 124 may use the percent change in, for example, the number of bug requests from two days ago, or a week ago, to the present to calculate the momentum score. In some implementations, the period used to calculate the percent change may be set by a system administrator and may be different for each momentum factor. Accordingly, the number of changes may be determined over a period of a week while the number of contributors may be determined over a period of one month. In calculating the momentum score for a file, indexer 124 may consider any number of the momentum factors or may consider only one of the factors. In some implementations, some momentum factors, such as the number of changes, may be weighted more than the other factors, such as feature requests when calculating the momentum score. In some implementations, each factor may be considered a separate momentum score. After calculating the momentum scores, in some implementations indexer 124 may store the momentum scores as part of code repository index 132.

Indexer 124 may also determine a social signal score for a file (step 325). In a code repository where software developers can mark source code files as important, indexer 124 may use this information to boost the priority score of the file. In one implementation, source code marked as important by many software developers will receive a higher social signal score than code marked as important by a few software developers. In some implementations, source code marked as important by developers in the same work group as a query requestor may receive a higher social signal score than source code marked as important by developers outside the same work group. In such implementations, indexer 124 may store a social signal by work group and the query processor 126 may use the appropriate social signal score, based on the query requestor, to calculate a priority score.

In some implementations, the indexer 124 may store the version score, the build status score, the momentum score, and/or the social signal score in a memory after determining the various scores. In such implementations, the scores may be available for query processor 126 to use to calculate a priority score after a query has been received (step 330). In other implementations, indexer 124 may calculate the priority score from the version, build status, momentum, and/or social signal scores and store the priority score for each file (step 330). In some implementations the priority score may also include values from other calculated scores, such as one or more association scores, a file type score, etc. In some implementations query processor 126 or indexer 124 may add the scores together to arrive at a priority score. In such implementations the build status score may be represented by a negative number because it deflates the priority score. In some implementations, the indexer 124 or query processor 126 may assign a weight each score before adding them to calculate the priority score. For instance, the weights may be determined by an automatic optimization method causing, for example, the version score or the momentum score to receive more weight than the social signal score.

In some implementations, the scores may be multiplied by their assigned weight before adding the weighted scores together to calculate the priority score. In some implementations indexer 124 or query processor 126 may average the raw scores or the weighted scores to calculate the priority score. In some implementations, the query processor may receive an indication from a query requestor that one or more of the factors should be ignored, which may cause the query processor 126 to weight that factor at zero. In some implementations a machine-learning process may be used to calculate the priority score from the various scores. As discussed above, in some implementations the query processor 126 may receive an indication from the query requestor that one of the factors should be inverted. For example, the query requestor may indicate that older versions should be considered more of a priority than newer versions, and therefore the query processor 126 may calculate the priority score using, for example, the inverse of the calculated version score. The inverse score may be the maximum possible score minus the calculated score. After calculating the priority score, or at least the scores that make up the priority score, process 300 ends.

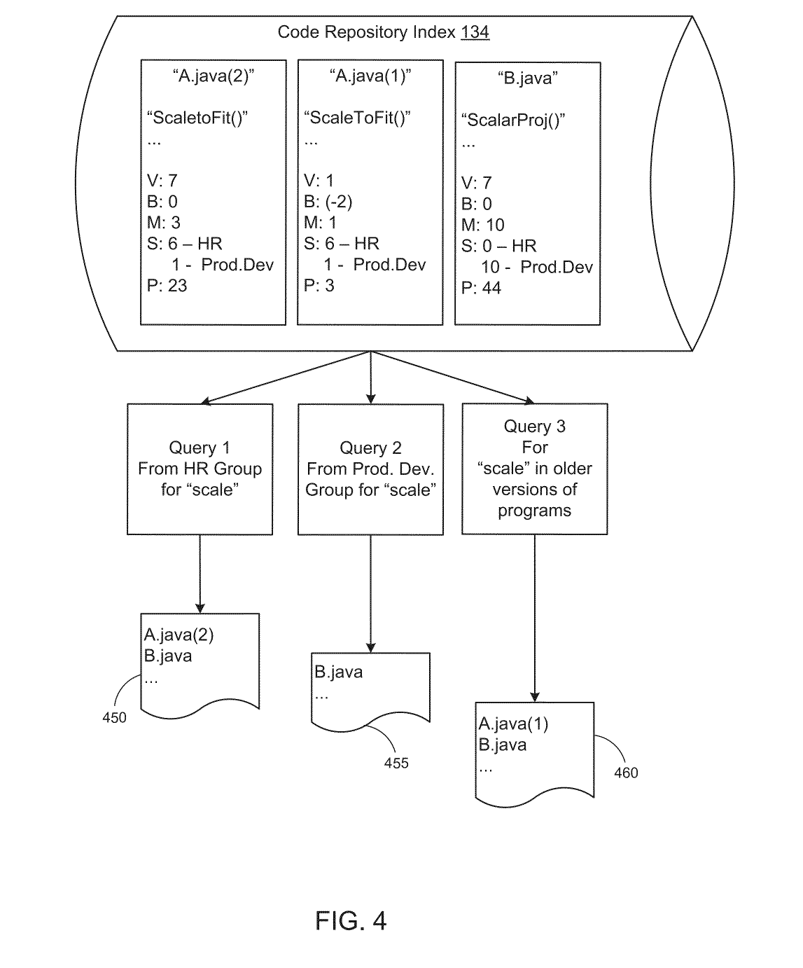

An example of a query resolution process will now be explained using the example data of FIG. 4. The data shown in FIG. 4 is for illustration only and should not be construed to limit the disclosed methods and systems. As shown in FIG. 4, code repository 134 may contain entries for the source code files for two versions of “A.java” and one version of “B.java.” FIG. 4 shows three files for the sake of brevity, but code repository 134 may contain hundreds or thousands of files. Indexer 124 may have already calculated a version score (V), a build score (B), a momentum score (M), a social signal score (S), and a priority score (P) for each of the three files shown. In the example of FIG. 4, the version score may have a weight of two, and the momentum score may have a weight of three. Thus, the priority score for A.java(2) may be 14+0+9=23. In some implementations the priority score for A.java(2) may be 30, which includes the total social signal score of seven. The priority score for A.java(1) may be 2+(−2)+3=3. A.java(1) may have a build score of −2 because the code no longer compiles, but it is fairly recent (so the build score is not higher than 2). B.java. may have a priority score of 14+0+30=44. Similarly, in some implementations the priority score may include the total of the social signals and stored as 54.

At some point in time a requestor from the HR group may submit query 1, which searches the code repository for “scale.” In the example of FIG. 4, the system administrator may have set a minimum priority score of 25. Thus, in responding to the query, query processor 126 may look for files with a priority score of 25 or higher to return the first set of search results 450. In some implementations, query processor may add the social score for the HR group to the priority score before determining whether the priority score meets the threshold of 25. In the example of FIG. 4, files “A.java(2)” and “B.java” meet the threshold and may be included in the search results 450, assuming they are responsive to the query. Because the search was for “scale,” and A.java(2) contains a function “ScaleToFit( )”, A.java(2) may have a relatively high relevance score. Conversely, B.java does not match “scale” but has a function of “ScalarProj( )” so although it may be considered responsive, its relevance score may be lower.

In some implementations, query processor 126 may boost the relevance score of B.java by the priority score of B.java. In the example of FIG. 4 this may be 44. B.java may have a high version score and a high momentum score because it is a recent file being worked on currently by many different people with many recent bug reports and feature requests, etc. Because of this, B.java may receive a total score (relevance score plus priority score) that puts it higher in a results list than other files, and possibly even higher than A.java(2). Because A.java(1) did not have a minimum priority score of 25, A.java(1) may not appear at all in the search results 450 for Query 1. But, if a minimum number of responsive files with a minimum priority score of 25 were not found, query processor 126 may look at A.java(1), although it may not appear in the first set of search results.

A requestor from the product development group may submit query 2, which also searches the code repository for “scale.” Because this query requestor is not from the HR group, in some implementations the social signal for HR may not be added to the priority score and A.java(2) may not meet the minimum priority score of 25 and may not be included in the search results 455. Thus, like A.java(1), query processor 126 may not even search A.java(1) for responsiveness unless a minimum number of files could not be found. In other implementations, the total social signal score may be added into the priority score and A.java(2) may meet the threshold of 25.

A requestor from the HR group may submit query 3, which indicates that older versions should be given higher weight and also searches for “scale” within the code repository. Because older versions are to be given more weight, the version score for A.java(2) and A.java(1) may be inverted. For example, if the highest version score is 10, the version score for A.java(2) may become 3 and the version score for A.java(1) may become 9. Thus, the new priority score for A.java(1) may be 18+(−2)+3+6=25 while the priority score for A.java(2) may be 6+0+9+6=21. Thus, for query 3, A.java(1) may meet the priority score threshold of 25 but A.java(2) may not. In this example, A.java(1) and B.java may be included in the initial search results 460 while A.java(2) is not.

The example of FIG. 4 demonstrates that using the priority score the query processor 126 can cull documents before they are examined for responsiveness while still ensuring that important documents are not missed, but that the system may be flexible enough to customize the priority score based on the query requestor and/or other query properties.

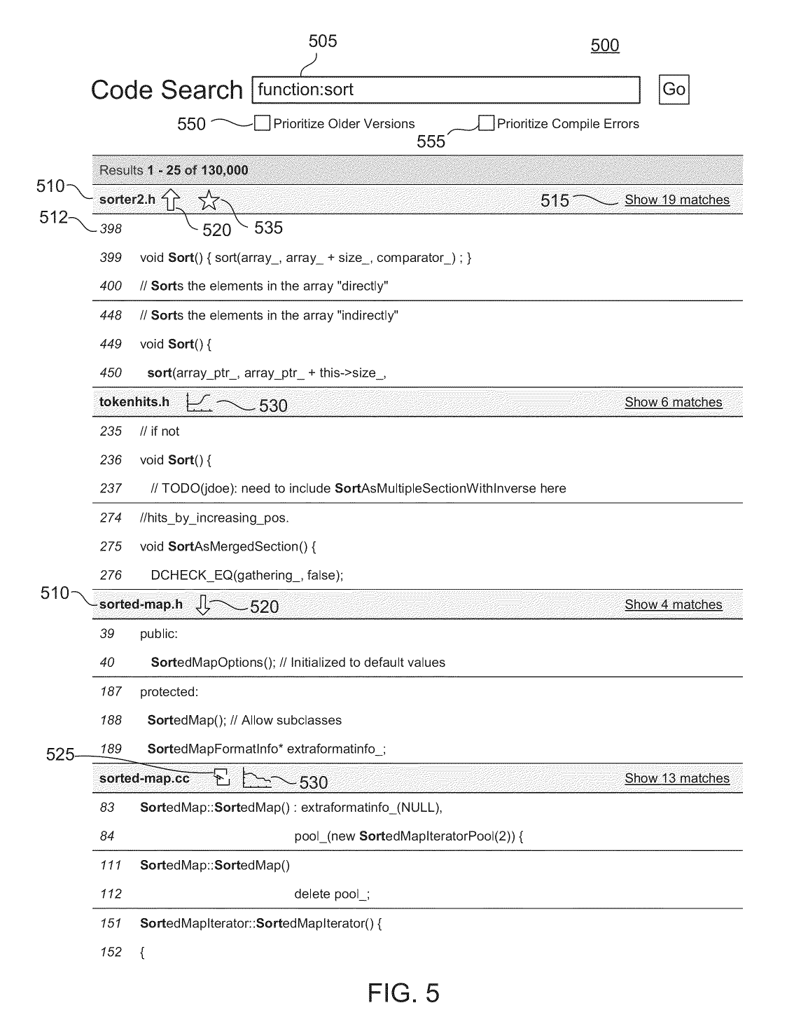

FIG. 5 illustrates an example of a user interface 500 showing a results list after searching a code repository. The user interface 500 may be generated, for example, by a user interface module such as module 128 of FIG. 1. The user interface 500 may include a text box 505 where the user may provide search criteria. The search system 100 may use the search criteria to search the code repository, for example as described with regard to FIG. 2. The user interface 500 may include information used to convey search results to the user, for example as part of step 235 of FIG. 2. The search results may include the name of the document(s) 510 included in the result list for the search query 505. User interface 500 may also include line numbers 512 of statements from documents in the result list. For example, the user interface 500 may include one or more lines that precede a line responsive to the search query and/or one or more lines that follow the responsive line. User interface 500 may display the first few matches from a particular document and include a link 515 that enables the user to select more matches from the document.

User interface 500 may also include depictions of signals used to calculate a priority score for the responsive documents 510. As explained above, a priority score may include, among other things, a version score, a build status score, a momentum score, and a social signal score. User interface 500 may include, for example, an icon 520 that indicates that the version score boosted or lowered the priority score. For example, an arrow pointing up may indicate that the version score boosted the priority score and an arrow pointing down may indicate that the version score lowered the priority score. User interface 500 may also include an icon 525 indicating a build status score lowered the priority score for the document because the document does not currently compile successfully. User interface 500 may also include an icon 530 indicating the momentum score for a document. The icon 530 may be a spark line that indicates the trend of the momentum score over some period of time. For example, icon 530 may illustrate that the document has had an increase in the number of contributors during the last week, or that the document had a large number of bug reports a month ago but the number of reports has fallen since then. The spark line may be for a week, a month, or some other period of time. User interface 500 may also include an icon 535 that indicates the social signal score for a document. For example, user interface 500 may include a star or heart if the document has been tagged as important by members of the team that a query requestor belongs to. In some implementations user interface 500 may include a number of starts, with a higher number of stars indicating a stronger social signal score. As demonstrated in FIG. 5, each document 510 may include icons representing two or more scores.

User interface 500 may also include options 550 and 555 that allow the query requester to determine how various signals affect the priority score. For example, the query requestor may select box 550 before the query is submitted to tell the query processor, such as query processor 126, to generate a version score for older versions that boosts the priority score more than a version score for newer versions. User interface 500 may additionally include box 555. Box 555 may allow the query requestor to tell the query processor to generate a build score that boosts the priority score more than code that does not currently compile. Other such options may be included in user interface 500. User interface 500 of FIG. 5 offers one example of a user interface that can be used to convey information to the user regarding how various signals apply to the search results. Other icons and signals may also be included on such a user interface.

FIG. 6 shows an example of a generic computer device 600 and a generic mobile computer device 650, which may be used with the techniques described here. Computing device 600 is intended to represent various forms of digital computers, e.g., laptops, desktops, workstations, personal digital assistants, servers, blade servers, mainframes, and other appropriate computers. Computing device 650 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, for example, display 616 coupled to high speed interface 608. In some implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, for example, a magnetic or optical disk.

The storage device 606 is capable of providing mass storage for the computing device 600. In one implementation, the storage device 606 may be or contain a computer-readable medium, for example, a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, for example, the memory 604, the storage device 606, or memory on processor 602.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, for example, a keyboard, a pointing device, a scanner, or a networking device, for example a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer like laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provided as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652, that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smart phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” “computer-readable medium” and “computer-readable storage device” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A computer-implemented method comprising:
for each file associated with a code repository:
calculating, by one or more processors, a priority score for the file, wherein the priority score is based on at least one of a version score, a build status, a momentum score, and a social score, and
storing the priority score in the code repository;
receiving a search query for the code repository;
using the stored priority scores to limit the files searched to determine files responsive to the query;
using the priority score to generate a result list from the responsive files; and
generating data used to display the result list.

2. The method of claim 1, further comprising:
combining the priority score and a relevance score for each of the files in the result list; and
ordering the result list based on the combined priority score and relevance score.

3. The method of claim 1, wherein using the priority score to limit the files searched includes initially limiting the files searched for responsiveness to files having a minimum priority score.

4. The method of claim 1, wherein the momentum score is based on a frequency with which the file changes and a first file with an increasing number of changes over a time period has a higher momentum score than a second file with a decreasing number of changes over the time period.

5. The method of claim 1, wherein the momentum score is based on the number of contributors to the file and a first file with an increasing number of contributors over a time period has a higher momentum score than a second file with a decreasing number of contributors over the time period.

6. The method of claim 1, wherein the momentum score is based on bug reports for a project associated with the file.

7. The method of claim 1, wherein the social score is based on the number of contributors that have marked the file as important.

8. The method of claim 1, wherein the social score is stored by work group and, after receiving the search query, the method further comprises:
determining a work group to which a requestor of the query belongs; and
boosting the priority score when the work group to which the requestor belongs has a non-zero social score.

9. The method of claim 1, wherein the build status reduces the priority score for a file.

10. The method of claim 9, wherein the priority score reduction is based on a date that the file was last modified.

11. The method of claim 10, wherein a first file with a more recent modified date has a smaller score reduction than a second file with an older modified date.

12. The method of claim 10, wherein the priority score reduction is zero for a first file when a modified date newer than a threshold date.

13. The method of claim 1, wherein an older version of a file has a lower version score than a more recent version of the file.

14. A computer-readable storage device for searching documents, the storage device having recorded and embodied thereon instructions that, when executed by one or more processors of a computer system, cause the computer system to:
for each file associated with a code repository:
calculate a priority score for the file, wherein the priority score is based on at least one of a version score, a build status, a momentum score, and a social score, and
store the priority score in the code repository;
receive a search query for the code repository;
use the stored priority scores to limit the files searched to determine files responsive to the query;
use the priority score to generate a result list from the responsive files; and
generate data used to display the result list.

15. A system comprising:
one or more processors; and
a memory storing instructions that, when executed by the one or more processors, are configured to cause the system to perform operations comprising:
for each file associated with a code repository:
calculating a priority score for the file, wherein the priority score is based on at least one of a version score, a build status, a momentum score, and a social score, and
storing the priority score in the code repository;
receiving a search query for the code repository;
using the stored priority scores to limit the files searched in determining files responsive to the query;
using the priority score, generate a result list from the responsive files; and
generating data used to display the result list.

16. The system of claim 15, further comprising instructions configured to cause the system to perform the operation of ordering the result list based on the priority score and a relevance score.

17. The system of claim 15, wherein the momentum score has a higher weighting than the build status and the social score for the file in the priority score.

18. The system of claim 15, wherein the build status reduces the priority score for a file.

19. The system of claim 15, wherein the momentum score is based on a frequency with which the file changes and a file with an increasing number of changes over a time period has a higher momentum score than a file with a decreasing number of changes over the time period.

20. The system of claim 15, wherein the priority score is based on at least the version score and as part of the calculating operation the instructions perform the operations of:
receiving an indication that older versions are more desirable; and
inverting the version score portion of the priority score prior to using the priority score to determine files responsive to the query.

21. The method of claim 1, wherein the data used to display the result list includes at least one icon representing at least one of the version score, the build status, the momentum score, and the social score that changed a relevance score for the file.
